(19) United States
(12) Patent Application Publication
(10) Pub. No.: US 2026/0323772 A1
(43) Pub. Date: Oct. 15, 2026

(54) SUPPORTING MULTICAST AND BROADCAST SERVICES IN A STAND-ALONE NON-PUBLIC NETWORK

(71) Applicant: QUALCOMM Incorporated, San Diego, CA (US)

(72) Inventors: Umesh PHUYAL, San Diego, CA (US); Prasad Reddy KADIRI, San Diego, CA (US); Haris ZISIMOPOULOS, London (GB); Alberto RICO ALVARINO, San Diego, CA (US)

(21) Appl. No.: 19/120,022

(22) PCT Filed: Jul. 26, 2023
(86) PCT No.: PCT/US2023/071056

§ 371 Date: Apr. 10, 2025

(30) Foreign Application Priority Data
Nov. 10, 2022 (GR) 20220100926

(51) Int. Cl. H04W 76/40; H04W 76/11; H04W 84/06

(52) U.S. Cl. CPC H04W 76/40; H04W 76/11; H04W 84/06

(57) ABSTRACT

Various aspects described herein relate generally to supporting multicast and broadcast services (MBS) in a stand-alone non-public network (SNPN). Some aspects more specifically relate to providing information associated with a network identifier (NID) of an SNPN in a temporary mobile group identifier (TMGI) to enable MBS in the SNPN. In some aspects, a user equipment (UE) may receive a configuration indicating a TMGI corresponding to an MBS session identifier (ID) associated with an MBS session provided by an SNPN, where the TMGI includes an NID index value or a unique service ID. The UE may then receive communication associated with the MBS session based at least in part on an NID to which the NID index value is mapped or based at least in part on the unique service ID.

### CROSS-REFERENCE TO RELATED APPLICATION

This Patent Application claims priority to Greek Patent Application No. 20220100926, filed on Nov. 10, 2022, entitled “SUPPORTING MULTICAST AND BROADCAST SERVICES IN A STAND-ALONE NON-PUBLIC NETWORK,” and assigned to the assignee hereof. The disclosure of the prior Applications is considered part of and is incorporated by reference into this Patent Application.

### FIELD OF THE DISCLOSURE

Aspects of the present disclosure generally relate to wireless communication and specifically, to techniques and apparatuses for supporting multicast and broadcast services (MBS) in a stand-alone non-public network (SNPN).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

A stand-alone non-public network (SNPN) is a non-public network (NPN) that does not rely on network functions provided by a public land mobile network (PLMN). An SNPN identifier (ID) is defined by a combination of a PLMN identifier (PLMN ID) and a network identifier (NID). A multicast and broadcast services (MBS) session is a session that enables point-to-multipoint service, meaning that a single transmitter can broadcast or multicast the same content for reception by multiple UEs. A temporary mobile group identifier (TMGI) may be used to identify an MBS session. A TMGI is defined by a combination of a PLMN ID and a service ID. A TMGI is not defined to include an SNPN ID and, therefore, a TMGI does not provide any indication of an NID associated with an SNPN. Conventional techniques to support MBS in an SNPN are inadequate. For example, a UE-based technique according to which a UE does not determine an NID associated with an MBS session provided by an SNPN is inadequate in a radio access network (RAN) sharing scenario. As another example, a technique according to which a list of full NIDs is signaled to a UE in an MBS broadcast configuration via radio resource control (RRC) signaling dramatically increases signaling overhead.

### SUMMARY

Some aspects described herein relate to a user equipment (UE) for wireless communication. The UE may include at least one memory and at least one processor communicatively coupled with the at least one memory. The at least one processor may be operable to cause the UE to receive a configuration indicating a temporary mobile group identifier (TMGI) corresponding to a multicast and broadcast services (MBS) session identifier associated with an MBS session provided by a stand-alone non-public network (SNPN), the TMGI including a network identifier (NID) index value. The at least one processor may be operable to cause the UE to map the NID index value to an NID associated with the SNPN providing the MBS session. The at least one processor may be operable to cause the UE to receive a communication associated with the MBS session based at least in part on the NID.

Some aspects described herein relate to a network node for wireless communication. The network node may include at least one memory and at least one processor communicatively coupled with the at least one memory. The at least one processor may be operable to cause the network node to transmit a configuration indicating a TMGI associated with an MBS session identifier associated with an MBS session provided by an SNPN, the TMGI including an NID index value corresponding to an NID associated with the MBS session. The at least one processor may be operable to cause the network node to transmit a communication associated with the MBS session for reception by a UE.

Some aspects described herein relate to a UE for wireless communication. The UE may include at least one memory and at least one processor communicatively coupled with the at least one memory. The at least one processor may be operable to cause the UE to receive a configuration indicating a TMGI corresponding to an MBS session identifier associated with an MBS session provided by an SNPN, the TMGI including a service identifier that is unique across a set of radio access network (RAN) sharing networks including one or more SNPNs or one or more public land mobile networks (PLMNs). The at least one processor may be operable to cause the UE to receive a communication associated with the MBS session based at least in part on the service identifier being unique across the set of RAN sharing networks.

Some aspects described herein relate to a network node for wireless communication. The network node may include at least one memory and at least one processor communicatively coupled with the at least one memory. The at least one processor may be operable to cause the network node to assign a service identifier to an MBS session provided by an SNPN, the service identifier being unique across a set of RAN sharing networks including one or more SNPNs or one or more PLMNs. The at least one processor may be operable to cause the network node to transmit a configuration indicating a TMGI corresponding to an MBS session identifier associated with the MBS session, the TMGI including the service identifier. The at least one processor may be operable to cause the network node to transmit a communication associated with the MBS session for reception by a UE.

Some aspects described herein relate to a method of wireless communication performed by a UE. The method may include receiving a configuration indicating a TMGI corresponding to an MBS session identifier associated with an MBS session provided by an SNPN, the TMGI including an NID index value. The method may include mapping the NID index value to an NID associated with the SNPN providing the MBS session. The method may include receiving a communication associated with the MBS session based at least in part on the NID.

Some aspects described herein relate to a method of wireless communication performed by a network node. The method may include transmitting a configuration indicating a TMGI associated with an MBS session identifier associated with an MBS session provided by an SNPN, the TMGI including an NID index value corresponding to an NID associated with the MBS session. The method may include transmitting a communication associated with the MBS session for reception by a UE.

Some aspects described herein relate to a method of wireless communication performed by a UE. The method may include receiving a configuration indicating a TMGI corresponding to an MBS session identifier associated with an MBS session provided by an SNPN, the TMGI including a service identifier that is unique across a set of RAN sharing networks including one or more SNPNs or one or more PLMNs. The method may include receiving a communication associated with the MBS session based at least in part on the service identifier being unique across the set of RAN sharing networks.

Some aspects described herein relate to a method of wireless communication performed by a network node. The method may include assigning a service identifier to an MBS session provided by an SNPN, the service identifier being unique across a set of RAN sharing networks including one or more SNPNs or one or more PLMNs. The method may include transmitting a configuration indicating a TMGI corresponding to an MBS session identifier associated with the MBS session, the TMGI including the service identifier. The method may include transmitting a communication associated with the MBS session for reception by a UE.

Some aspects described herein relate to a non-transitory computer-readable medium that stores a set of instructions for wireless communication by a UE. The set of instructions, when executed by one or more processors of the UE, may cause the UE to receive a configuration indicating a TMGI corresponding to an MBS session identifier associated with an MBS session provided by an SNPN, the TMGI including an NID index value. The set of instructions, when executed by one or more processors of the UE, may cause the UE to map the NID index value to an NID associated with the SNPN providing the MBS session. The set of instructions, when executed by one or more processors of the UE, may cause the UE to receive a communication associated with the MBS session based at least in part on the NID.

Some aspects described herein relate to a non-transitory computer-readable medium that stores a set of instructions for wireless communication by a network node. The set of instructions, when executed by one or more processors of the network node, may cause the network node to transmit a configuration indicating a TMGI associated with an MBS session identifier associated with an MBS session provided by an SNPN, the TMGI including an NID index value corresponding to an NID associated with the MBS session. The set of instructions, when executed by one or more processors of the network node, may cause the network node to transmit a communication associated with the MBS session for reception by a UE.

Some aspects described herein relate to a non-transitory computer-readable medium that stores a set of instructions for wireless communication by a UE. The set of instructions, when executed by one or more processors of the UE, may cause the UE to receive a configuration indicating a TMGI corresponding to an MBS session identifier associated with an MBS session provided by an SNPN, the TMGI including a service identifier that is unique across a set of RAN sharing networks including one or more SNPNs or one or more PLMNs. The set of instructions, when executed by the one or more processors of the UE, may cause the UE to receive a communication associated with the MBS session based at least in part on the service identifier being unique across the set of RAN sharing networks.

Some aspects described herein relate to a non-transitory computer-readable medium that stores a set of instructions for wireless communication by a network node. The set of instructions, when executed by one or more processors of the network node, may cause the network node to assign a service identifier to an MBS session provided by an SNPN, the service identifier being unique across a set of RAN sharing networks including one or more SNPNs or one or more PLMNs. The set of instructions, when executed by one or more processors of the network node, may cause the network node to transmit a configuration indicating a TMGI corresponding to an MBS session identifier associated with the MBS session, the TMGI including the service identifier. The set of instructions, when executed by one or more processors of the network node, may cause the network node to transmit a communication associated with the MBS session for reception by a UE.

Some aspects described herein relate to an apparatus for wireless communication. The apparatus may include means for receiving a configuration indicating a TMGI corresponding to an MBS session identifier associated with an MBS session provided by an SNPN, the TMGI including an NID index value. The apparatus may include means for mapping the NID index value to an NID associated with the SNPN providing the MBS session. The apparatus may include means for receiving a communication associated with the MBS session based at least in part on the NID.

Some aspects described herein relate to an apparatus for wireless communication. The apparatus may include means for transmitting a configuration indicating a TMGI associated with an MBS session identifier associated with an MBS session provided by an SNPN, the TMGI including an NID index value corresponding to an NID associated with the MBS session. The apparatus may include means for transmitting a communication associated with the MBS session for reception by a UE.

Some aspects described herein relate to an apparatus for wireless communication. The apparatus may include means for receiving a configuration indicating a TMGI corresponding to an MBS session identifier associated with an MBS session provided by an SNPN, the TMGI including a service identifier that is unique across a set of RAN sharing networks including one or more SNPNs or one or more PLMNs. The apparatus may include means for receiving a communication associated with the MBS session based at least in part on the service identifier being unique across the set of RAN sharing networks.

Some aspects described herein relate to an apparatus for wireless communication. The apparatus may include means for assigning a service identifier to an MBS session provided by an SNPN, the service identifier being unique across a set of RAN sharing networks including one or more SNPNs or one or more PLMNs. The apparatus may include means for transmitting a configuration indicating a TMGI corresponding to an MBS session identifier associated with the IBS session, the TMGI including the service identifier. The apparatus may include means for transmitting a communication associated with the MBS session for reception by a UE.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example associated with supporting multicast and broadcast services (MBS) in a stand-alone non-public network (SNPN) in accordance with the present disclosure.

FIG. 5 is a diagram illustrating an example associated with supporting MBS in an SNPN in accordance with the present disclosure.

FIG. 6 is a flowchart illustrating an example process performed, for example, by a UE that supports MBS in an SNPN in accordance with the present disclosure.

FIG. 7 is a flowchart illustrating an example process performed, for example, by a network node that supports MBS in an SNPN in accordance with the present disclosure.

FIG. 8 is a flowchart illustrating an example process performed, for example, by a UE that supports MBS in an SNPN in accordance with the present disclosure.

FIG. 9 is a flowchart illustrating an example process performed, for example, by a network node that supports MBS in an SNPN in accordance with the present disclosure.

FIG. 10 is a diagram of an example apparatus for wireless communication that supports MBS in an SNPN in accordance with the present disclosure.

FIG. 11 is a diagram of an example apparatus for wireless communication that supports MBS in an SNPN in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to supporting multicast and broadcast services (MBS) in a stand-alone non-public network (SNPN). Some aspects more specifically relate to providing information associated with a network identifier (NID) of an SNPN in a temporary mobile group identifier (TMGI) to enable NBS in the SNPN. In some aspects, a network node may transmit, and a user equipment (UE) may receive, a configuration indicating a TMGI corresponding to an NBS session identifier (ID) associated with an NBS session provided by an SNPN, where the TMGI includes an NID index value. Here, the UE may map the NID index value to an NID associated with the SNPN. The network node may transmit, and the UE may receive, a communication associated with the MBS session based at least in part on the NID. Additionally or alternatively, a network node may assign a service ID to an MBS session provided by an SNPN, where the service ID is unique across a set of radio access network (RAN) sharing networks. Here, the network node may transmit, and a UE may receive, a configuration indicating a TMGI corresponding to an MBS session identifier associated with the MBS session, where the TMGI includes the service ID. The network node may transmit, and the UE may receive, a communication associated with the MBS session based at least in part on the service ID.

Particular aspects of the subject matter described in this disclosure can be implemented to realize one or more of the following potential advantages. In some examples, the described techniques can be used to enable support of MBS in an SNPN, thereby providing the advantages of MBS (for example, increased network efficiency or increased resource usage efficiency) for an SNPN. Further, the described techniques can enable support of MBS in an SNPN without a significant increase in signaling overhead (for example, as compared to a technique that signals full NIDs). Additionally, the described techniques can enable reliable support of NBS in an SNPN in a RAN sharing scenario.

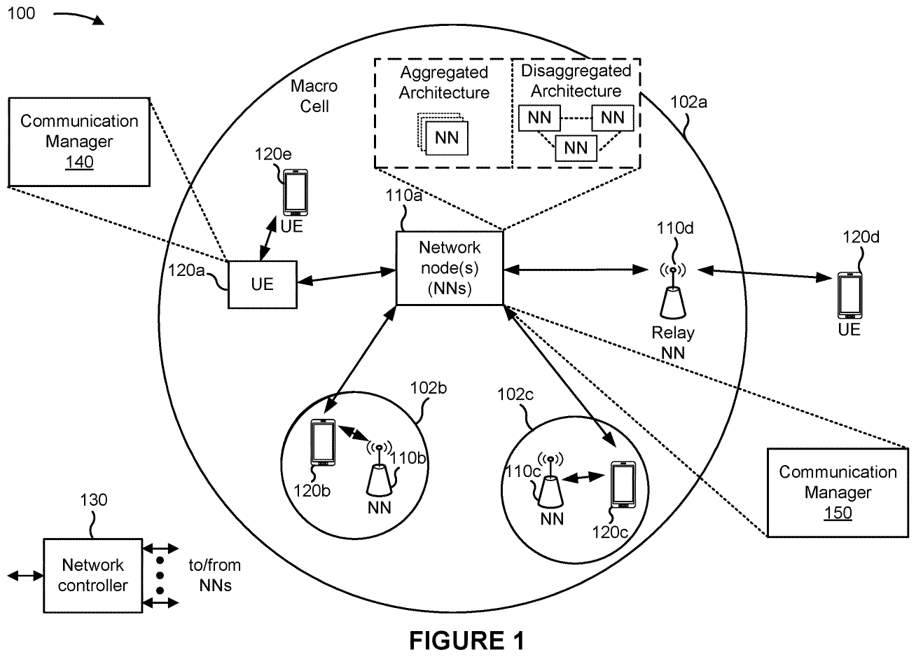

FIG. 1 is a diagram illustrating an example of a wireless network in accordance with the present disclosure. The wireless network 100 may be or may include elements of a 5G (for example, NR) network or a 4G (for example, Long Tenn Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may in some aspects receive a configuration indicating a TMGI corresponding to an MBS session identifier associated with an MBS session provided by an SNPN, the TMGI including an NID index value; map the NID index value to an NID associated with the SNPN providing the MBS session; and receive a communication associated with the MBS session based at least in part on the NID. Additionally or alternatively, as described in more detail elsewhere herein, the communication manager 140 may receive a configuration indicating a TMGI corresponding to an MBS session identifier associated with an MBS session provided by an SNPN, the TMGI including a service identifier that is unique across a set of RAN sharing networks including one or more SNPNs or one or more PLMNs; and receive a communication associated with the MBS session based at least in part on the service identifier being unique across the set of RAN sharing networks. Additionally or alternatively, the communication manager 140 may perform one or more other operations described herein.

In some aspects, the network node 110 may include a communication manager 150. As described in more detail elsewhere herein, the communication manager 150 may in some aspects transmit a configuration indicating a TMGI associated with an MBS session identifier associated with an MBS session provided by an SNPN, the TMGI including an NID index value corresponding to an NID associated with the MBS session; and transmit a communication associated with the MBS session for reception by a UE 120. Additionally or alternatively, as described in more detail elsewhere herein, the communication manager 150 may assign a service identifier to an MBS session provided by an SNPN, the service identifier being unique across a set of RAN sharing networks including one or more SNPNs or one or more PLMNs; transmit a configuration indicating a TMGI corresponding to an MBS session identifier associated with the MBS session, the TMGI including the service identifier; and transmit a communication associated with the MBS session for reception by a UE 120. Additionally or alternatively, the communication manager 150 may perform one or more other operations described herein.

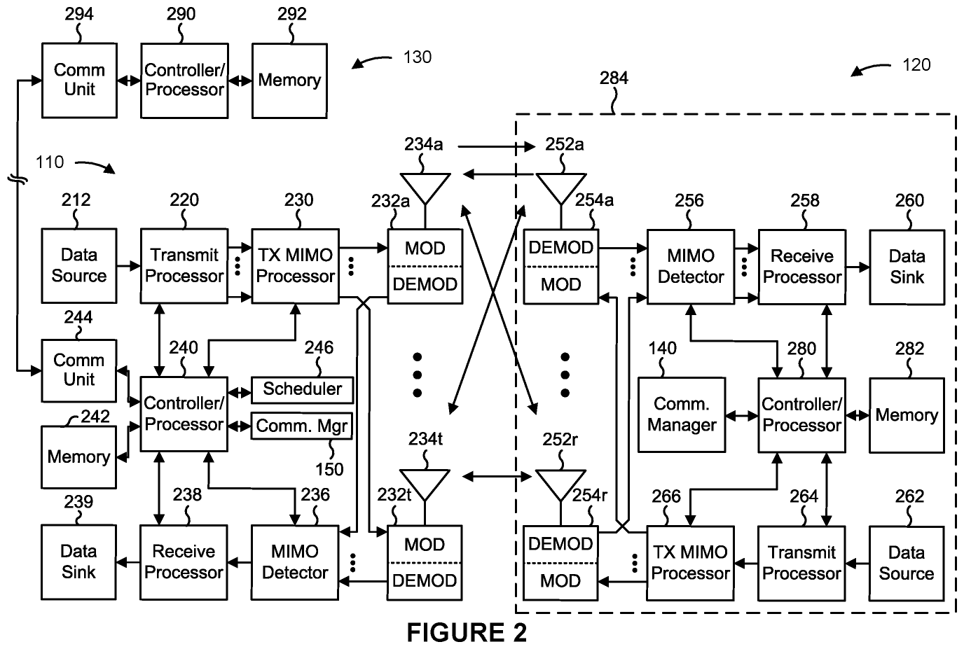

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

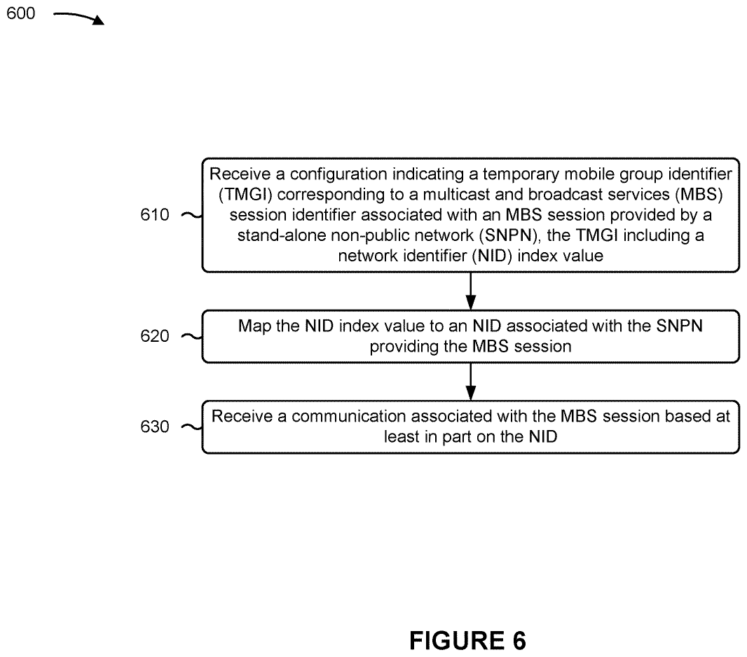

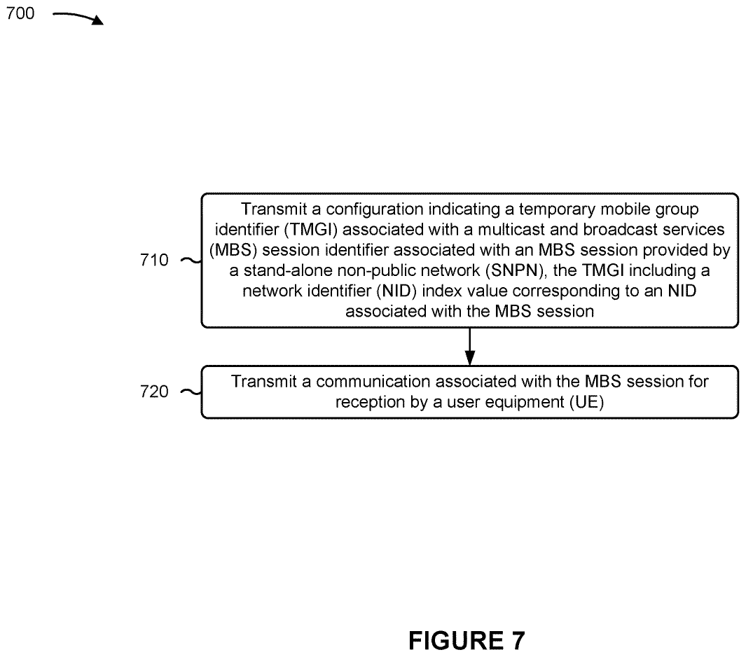

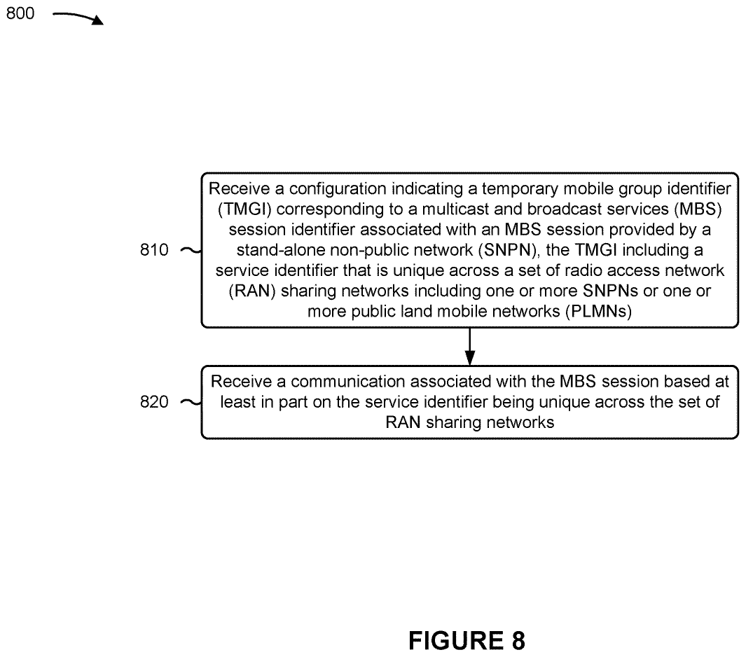

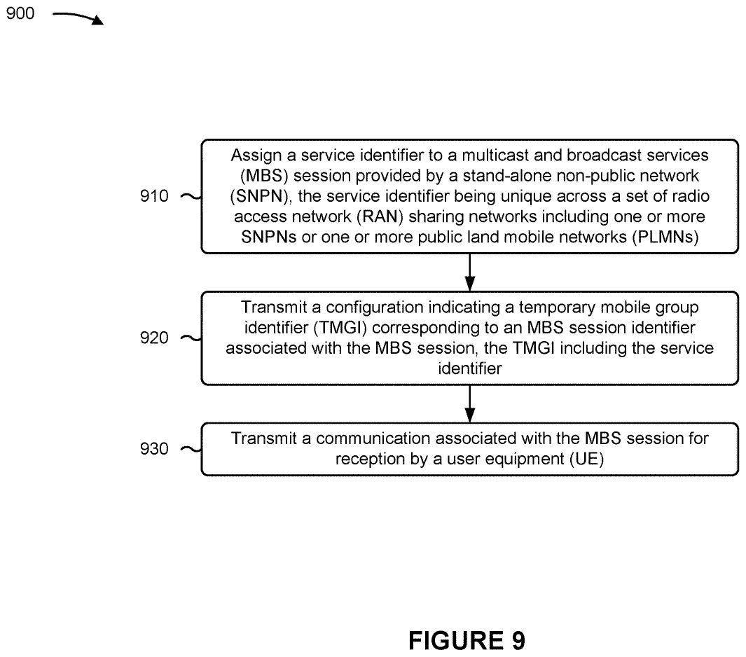

The controller/processor 240 of the network node 110, the controller/processor 280 of the UE 120, or any other component(s) of FIG. 2 may perform one or more techniques associated with supporting MBS in an SNPN, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, process 700 of FIG. 7, process 800 of FIG. 8, process 900 of FIG. 9, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, process 800 of FIG. 8, process 900 of FIG. 9, or other processes as described herein. In some examples, executing instructions may include running the instructions, converting the instructions, compiling the instructions, or interpreting the instructions, among other examples.

In some aspects, the UE 120 includes means for receiving a configuration indicating a TMGI corresponding to an MBS session identifier associated with an MBS session provided by an SNPN, the TMGI including an NID index value; means for mapping the NID index value to an NID associated with the SNPN providing the MBS session; or means for receiving a communication associated with the MBS session based at least in part on the NID. In some aspects, the UE includes means for receiving a configuration indicating a TMGI corresponding to an MBS session identifier associated with an MBS session provided by an SNPN, the TMGI including a service identifier that is unique across a set of RAN sharing networks including one or more SNPNs or one or more PLMNs; or means for receiving a communication associated with the MBS session based at least in part on the service identifier being unique across the set of RAN sharing networks. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a configuration indicating a TMGI associated with an MBS session identifier associated with an MBS session provided by an SNPN, the TMGI including an NID index value corresponding to an NID associated with the MBS session; or means for transmitting a communication associated with the MBS session for reception by a UE 120. In some aspects, the network node includes means for assigning a service identifier to an MBS session provided by an SNPN, the service identifier being unique across a set of RAN sharing networks including one or more SNPNs or one or more PLMNs; means for transmitting a configuration indicating a TMGI corresponding to an MBS session identifier associated with the MBS session, the TMGI including the service identifier; or means for transmitting a communication associated with the MBS session for reception by a UE 120. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

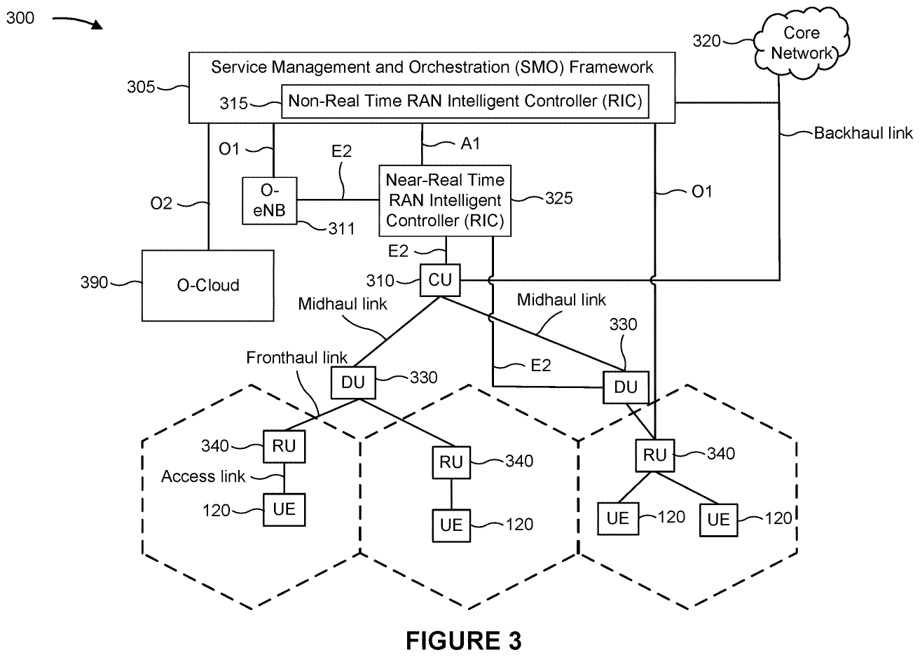

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), or control plane functionality (for example, Central Unit—Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

A non-public network (NPN) is a network that enables deployment of a radio access technology, such as 5G, for private use. An NPN may be deployed as a stand-alone NPN (SNPN) or as a public network integrated NPN (PNI-NPN). An SNPN is an NPN that does not rely on network functions provided by a public land mobile network (PLMN). A PNI-NPN is an NPN deployed with the support of a PLMN. An SNPN identifier (ID) is defined by a combination of a PLMN identifier (PLMN ID) and a network identifier (NID). An SNPN-enabled UE can be configured with a subscriber ID and credentials for each subscribed SNPN identified by the combination of PLMN ID and NID.

A multicast and broadcast services (MBS) session is a session that enables point-to-multipoint service, meaning that a single transmitter can broadcast or multicast the same content for reception by multiple UEs. A temporary mobile group identifier (TMGI) may be used to identify an NIBS session. For example, a TMGI may be used in association with configuring a multicast radio bearer (MRB) associated with a multicast service. As another example, a TMGI may be used as an MBS session ID for a broadcast service. A TMGI is defined by a combination of a PLMN ID and a service ID. Conventionally, a TMGI is not defined to include an SNPN ID and, therefore, a TMGI does not provide any indication of an NID associated with an SNPN.

In some systems, a UE-based technique can be deployed to support MBS in an SNPN. For example, a network node may broadcast a system information block 1 (SIB1) that includes one or more NIDs associated with one or more SNPNs. The network node can set up an F1 interface based on NID information included in an MBS session ID defined in, for example, an NG application protocol (AP), an Xn AP, an F1 AP, or an E1 AP. A UE that registers to an SNPN has knowledge of the network to which it is registered, and the UE may not be permitted to register to a non-NPN (for example, a PLMN 5G core network) while the UE is registered to the SNPN. Further, the UE has knowledge of the cell to/in which the UE is connected/camped. The UE can therefore determine an MBS control channel (MCCH) from the cell of the SNPN and determine a service ID (within a TMGI) to begin receiving an MBS service from the cell of the SNPN. Notably, according to this UE-based technique, there is no need for the UE to have access to or otherwise determine an NID from the TMGI.

However, the above-described UE-based technique may be inadequate to support RAN sharing. That is, the UE-based technique for supporting MBS in an SNPN may be inadequate in a scenario in which the SNPN shares a RAN with one or more other networks, such as one or more other SNPNs or one or more PLMNs. In such a scenario, the cell may provide MBS service(s) for the SNPN, but may also provide the same or different MBS service(s) for one or more other SNPNs or one or more other PLMNs. However, in a RAN sharing scenario, the network may use the same TMGI for multiple SNPNs or PLMNs. As a result, the UE may be unable to associate a TMGI with a particular SNPN or PLMN (when the same TMGI is used for multiple SNPNs or PLMNs).

One technique to address this issue is to include a list of NIDs in an MBS broadcast configuration provided to UEs via RRC signaling so that full NIDs corresponding to MBS session IDs are indicated in the MBS broadcast configuration. However, including a list of full NIDs in the MBS broadcast configuration can dramatically increase signaling overhead (for example, an NID may have a length of 44 bits, and up to 1024 MBS sessions may be configured).

Various aspects described herein relate generally to supporting MBS in an SNPN. Some aspects more specifically relate to providing information associated with an NID of an SNPN in a TMGI to enable MBS in the SNPN. In some aspects, a network node may transmit, and a UE may receive, a configuration indicating a TMGI corresponding to an MBS session ID associated with an MBS session provided by an SNPN, where the TMGI includes an NID index value. Here, the UE may map the NID index value to an NID associated with the SNPN. The network node may transmit, and the UE may receive, a communication associated with the MBS session based at least in part on the NID associated with the NID index value. Additionally or alternatively, a network node may assign a service ID to an MBS session provided by an SNPN, where the service identifier is unique across a set of RAN sharing networks. Here, the network node may transmit, and a UE may receive, a configuration indicating a TMGI corresponding to an MBS session identifier associated with the MBS session, where the TMGI includes the service ID. The network node may transmit, and the UE may receive, a communication associated with the MBS session.

Particular aspects of the subject matter described in this disclosure can be implemented to realize one or more of the following potential advantages. In some examples, the described techniques can be used to enable support of MBS in an SNPN, thereby providing the advantages of MBS (for example, increased network efficiency or increased resource usage efficiency) for an SNPN. Further, the described techniques can enable support of MBS in an SNPN without a significant increase in signaling overhead (for example, as compared to the technique described above that signals full NIDs). Additionally, the described techniques can enable reliable support of MBS in an SNPN in a RAN sharing scenario. Additional details are provided below.

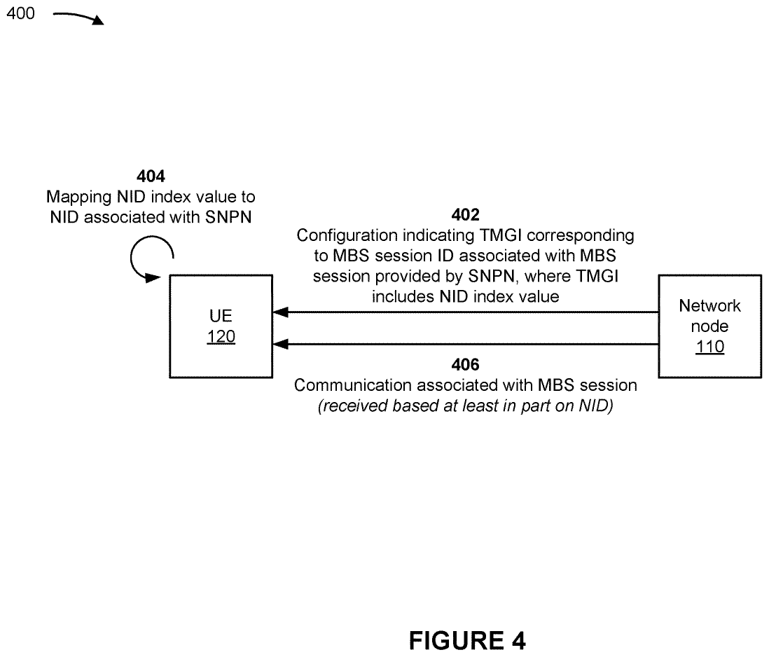

FIG. 4 is a diagram illustrating an example 400 associated with supporting MBS in an SNPN in accordance with the present disclosure. As shown in FIG. 4, example 400 includes communication between a network node 110 and a UE 120. In some aspects, the network node 110 and the UE 120 may be included in a wireless network, such as a wireless network 100. The network node 110 and the UE 120 may communicate via a wireless access link, which may include an uplink and a downlink.

As shown in FIG. 4, in a first operation 402, the network node 110 may transmit, and the UE 120 may receive, a configuration indicating a TMGI corresponding to an MBS session ID associated with an MBS session provided by an SNPN, where the TMGI includes an NID index value.

In some aspects, the configuration includes an MBS session information list indicating one or more TMGIs associated with one or more corresponding MBS session identifiers, where each TMGI of the one or more TMGIs includes one or more NID index values. For example, the configuration may include an MBS session information list (mbs-SessionfnfoList-vRRxy) that indicates one or more MBS session IDs (mbs-sessionId-vRRxy), where each MBS session ID comprises a TMGI (TMGI-vRRxy) and includes an NID index (nid-Index) or a plurality of NID indexes (nid-IndexList).

In some aspects, the MBS session information list is a first MBS session information list and the configuration includes a second MBS session information list. In some aspects, the second MBS session information list indicates one or more TMGIs associated with one or more corresponding PLMN IDs and one or more service IDs. That is, in some aspects, the configuration includes another MBS session information list (mbs-SessionInfoList-r17) that indicates one or more MBS session IDs (mbs-sessionId-r17), where each MBS session ID comprises a TMGI (TMGI-r17) and includes a PLMN ID (plmn-ID-r17) and a service ID (serviceId-r17). In some aspects, a number and order of MBS session identifiers included in the first MBS session information list matches a number and order of MBS session identifiers included in the second MBS session information list. That is, in some aspects, a number and order of MBS session IDs in the first MBS session information list (mbs-SessionfnfoList-vRRxy) matches a number and order of the MBS session IDs in the second MBS session information list (mbs-SessionInfoList-r17).

In some aspects, the first MBS session information list is separate from the second MBS session information list. That is, in some aspects, the first MBS session information list is provided in parallel to or separate from the second MBS session information list within the configuration.

Alternatively, in some aspects, the first MBS session information list is an extension of the second MIBS session information list. That is, in some aspects, the first MBS session information list is an extension of or is appended to the second MBS session information list within the configuration. In some aspects, the first MBS session information list being an extension of the second IBS session information list addresses the issue of backward compatibility. For example, a legacy UE that is not configured for MBS in SNPN may experience an error when interpreting a configuration including multiple MBS session information lists that include the same TMGI. Generating the configuration such that the first MUBS session information list is an extension of the second MUBS session information list addresses this issue since the second MIBS session information list would be invisible from the perspective of the legacy UE. As an alternative, any UEs (including legacy UEs) supporting MBS may be required to be configured to interpret multiple MBS session information lists. Alternatively, the network node 110 may be configured to provide the first MBS session information list in a RAN-sharing scenario only (thereby enabling a legacy UE to receive MBS via an SNPN in the case of no RAN-sharing).

In a second operation 404, the UE 120 may map the NID index value to an NID associated with the SNPN providing the MIBS session. That is, the UE 120 may map the NID index value included in the TMGI to an NID of the SNPN.

In some aspects, the UE 120 maps the NID index value to the NID by mapping the NID index value to an NID indicated in an NPN identity information list (npn-IdentityfnfoList). In some aspects, the NPN identity information list includes one or more NIDs associated with one or more SNPNs. In some aspects, the network node 110 may transmit, and the UE 120 may receive, the NPN identity information list in a system information block (SIB), such as SIB1.

In some aspects, a given element of the NPN identity information list includes an NPN identity list (npn-IdentityList), where each element in the NPN identity list can be set to PIN-NPN or to SNPN and each SNPN may have one or more NIDs. One example of an NPN identity information list is as follows:

```
npn-IdentityInfoList (size =2)
  npn-IdentityList [0] (size =3)
    npn-Identity [0] = snpn
      nid-List (size = 2)
        nid[0] = NID_x
        nid[1] = NID_y
    npn-Identity [1] = pni-npn
    npn-Identity [2] = snpn
      nid-List (size = 3)
        nid[0] = NID_a
        nid[1] = NID_x
        nid[2] = NID_b
  npn-IdentityList[1] (size = 2)
    npn-Identity[0] = pni-npn
    npn-Identity[1] = snpn
      nid-List (size = 1)
        nid[0] = NID_b
```

In this example, the NPN identity information list includes two NPN identity lists: npn-IdentityList [0] and npn-IdentityList [1]. The npn-IdentityList [0] includes three NPN identities: npn-Identity [0], npn-Identity [1], and npn-Identity [2]. With respect to npn-IdentityList [0], the npn-Identity [0] is set to SNPN and is associated with an NID list comprising 2 NIDs (NID_x and NID_y), the npn-Identity [1] is set to PNI-NPN, and the npn-Identity [2] is set to SNPN and is associated with an NID list comprising 3 NIDs (NID_a, NID_x, and NID_b). The npn-IdentityList [1] includes two NPN identities: npn-Identity [0] and npn-Identity [1]. With respect to npn-IdentityList [1], the npn-Identity [0] is set to PNI-NPN and the npn-Identity [1] is set to SNPN and is associated with an NID list comprising 1 NID (NID_b).

In some aspects, the UE 120 maps the NID index value to an NID included in the NPN identity information list in a mapping scheme. For example, the mapping scheme may indicate that an NID index value of 1 indicates the first NID in the first NPN identity in the first NPN identity list included in the NPN identity information list received in SIB1. The mapping scheme may further indicate that an NID index value of 2 indicates the second NID in the same NPN identity to which the value of 1 was mapped or, if no additional NIDs are included in the same NPN identity, the value of 2 indicates the NID listed first in a subsequent NPN identity within the same NPN identity list within the same SIB1, and so on. Applying this mapping scheme to the example NPN identity information list provided above, the UE 120 may map an NID index value of 1 to NID_x in npn-Identity[0] in npn-IdentityList[0], an NID index value of 2 to NID_y in npn-Identity[0] in npn-IdentityList[0], an NID index value of 3 to NID_a in npn-Identity[2] in npn-IdentityList[0], an NID index value of 4 to NID_x in npn-Identity[2] in npn-IdentityList[0], an NID index value of 5 to NID_b in npn-Identity[2] in npn-IdentityList[0], and an NID index value of 6 to NID_b in npn-Identity[1] in npn-IdentityList[1].

In this way, the UE 120 may map an NID index value included in a TMGI to an NID based at least in part on an NPN identity information list received in system information, thereby enabling signaling overhead to be reduced (as compared to communicating full NIDs in the configuration provided to the UE 120).

In a third operation 406, the network node 110 may transmit, and the UE 120 may receive, a communication associated with the MBS session based at least in part on the NID. For example, after mapping the NID index value included in the TMGI to an NID associated with the SNPN providing the MBS session, the UE 120 may start receiving the MBS service via the MBS session based at least in part on the NID.

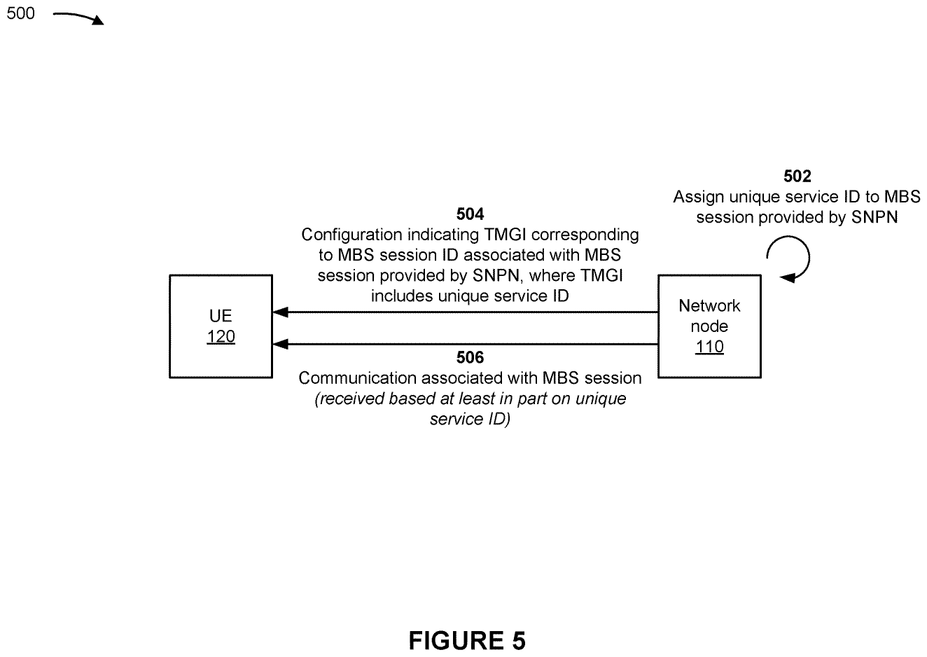

FIG. 5 is a diagram illustrating an example 500 associated with supporting MBS in an SNPN in accordance with the present disclosure. As shown in FIG. 5, example 500 includes communication between a network node 110 and a UE 120. In some aspects, the network node 110 and the UE 120 may be included in a wireless network, such as a wireless network 100. The network node 110 and the UE 120 may communicate via a wireless access link, which may include an uplink and a downlink.

As shown in FIG. 5, in a first operation 502, the network node 110 may assign a service ID to an MBS session provided by an SNPN. As indicated in FIG. 5, the network node 110 may in some aspects assign the service ID such that the service ID is unique across a set of RAN sharing networks including one or more SNPNs or one or more PLMNs.

In some aspects, the network node 110 assigns the service ID based at least in part on communicating with one or more other network nodes 110 to ensure that the service ID is unique across the set of RAN sharing networks. That is, in some aspects, network nodes 110 across the set of RAN sharing networks may communicate with one another to ensure that the service ID assigned to the MBS session is unique across the set of RAN sharing networks.

In some aspects, the network node 110 assigns the service ID based at least in part on a particular set of bits from an NID associated with the SNPN providing the MBS session. That is, in some aspects, the network node 110 may ensure that the service ID assigned to the MBS session is unique by using a particular set of bits from an NID value as part of the service ID. In some aspects, the particular set of bits may include one or more most significant bits (MSBs) of the NID or an NID value field of the NID. Additionally or alternatively, the particular set of bits may include one or more least significant bits (LSBs) of the NID or an NID value field of the NID.

For example, an NID may be defined by 44 bits, where 4 bits indicate an assignment mode and the remaining 40 bits indicate an NID value. Here, network nodes 110 across a set of RAN sharing networks may be configured to assign a 40-bit value in an NID value field in NIDs such that a combination of a given NID and a PLMN ID is globally unique. However, fewer than 40 bits may be sufficient to uniquely identify the NID within a local region where PLMNs may be shared (for example, within a country or a region). Here, an MBS service ID included in a TMGI comprise three octets (six hex digits or 24 bits). In an example, if the same TMGI is desired to be possible across different NIDs within the same SNPN, but not across different SNPNs and PLMNs, then a group of NIDs for each different SNPN or PLMN may be differentiated using MSBs of the NID value. As a particular example, if there are eight RAN sharing networks, then three MSBs in the NID value can be assigned such that the three MSBs uniquely identify each network, and the three MSBs of the NID value can be included in the service ID in the TMGI. Such an approach ensures that the same TMGI will not be used across the different SNPNs or PLMNs sharing the same RAN. Similarly, if 32 NID values are sufficient in the region and the TMGI is desired to be unique across different NIDs (even within the same SNPN), then the NIDs may be defined using five LSBs, and the five LSBs can be included in the service ID of the TMGI. Such an approach ensures that the same TMGI will not be used across different NIDs. In this way, coordination among network nodes 110 of RAN sharing networks can be utilized to ensure that the network node 110 assigns a unique service ID to the MBS session, thereby enabling MBS in an SNPN.

In a second operation 504, the network node 110 may transmit, and the UE 120 may receive, a configuration indicating a TMGI corresponding to an MBS session ID associated with the MBS session, where the TMGI includes the service ID. That is, the network node 110 may transmit, and the UE 120 may receive, the configuration including the service ID that is unique across the set of RAN sharing networks.

In a third operation 506, the network node 110 may transmit, and the UE 120 may receive, a communication associated with the MBS session. For example, the UE 120 may start receiving the MBS service via the MBS session based at least in part on the unique service ID. In some aspects, the UE 120 may receive the communication based at least in part on the service ID being unique across the set of RAN sharing networks. That is, because the service ID is unique across the set of RAN sharing networks, the TMGI is unique across the set of RAN sharing networks. Therefore, the same TMGI may not be used across the set of RAN sharing networks, which enables the UE 120 to associate the TMGI with a particular SNPN or PLMN and, therefore, start receiving the MBS service via the MBS session based at least in part on the (unique) service ID.

FIG. 6 is a flowchart illustrating an example process 600 performed, for example, by a UE that supports MBS in an SNPN in accordance with the present disclosure. Example process 600 is an example where the UE (for example, UE 120) performs operations associated with supporting MBS in an SNPN.

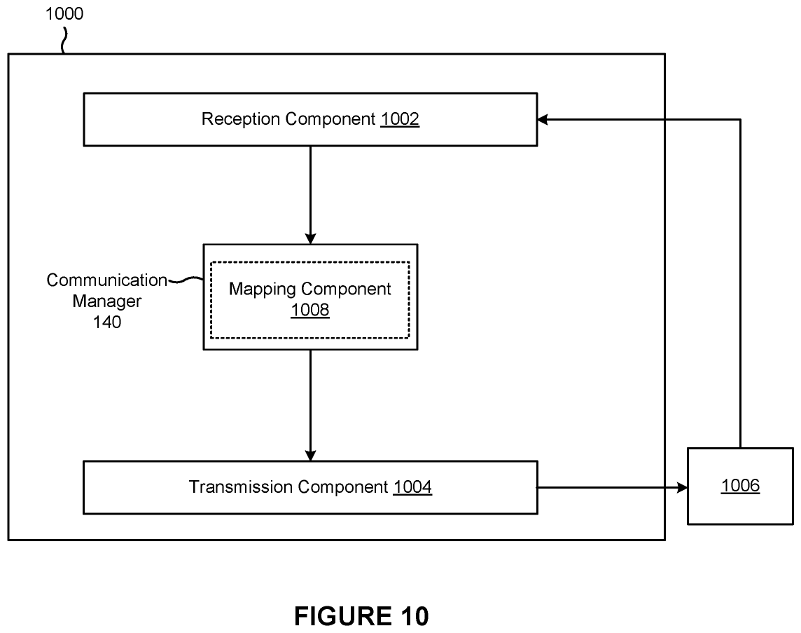

As shown in FIG. 6, in some aspects, process 600 may include receiving a configuration indicating a TMGI corresponding to an MBS session identifier associated with an MBS session provided by an SNPN, the TMGI including an NID index value (block 610). For example, the UE (such as by using communication manager 140 or reception component 1002, depicted in FIG. 10) may receive a configuration indicating a TMGI corresponding to an MBS session identifier associated with an MBS session provided by an SNPN, the TMGI including an NID index value, as described above.

As further shown in FIG. 6, in some aspects, process 600 may include mapping the NID index value to an NID associated with the SNPN providing the MBS session (block 620). For example, the UE (such as by using communication manager 140 or mapping component 1008, depicted in FIG. 10) may map the NID index value to an NID associated with the SNPN providing the MBS session, as described above.

As further shown in FIG. 6, in some aspects, process 600 may include receiving a communication associated with the MBS session based at least in part on the NID (block 630). For example, the UE (such as by using communication manager 140 or reception component 1002, depicted in FIG. 10) may receive a communication associated with the MBS session based at least in part on the NID, as described above.

Process 600 may include additional aspects, such as any single aspect or any combination of aspects described below or in connection with one or more other processes described elsewhere herein.

In a first additional aspect, the configuration includes an MBS session information list indicating one or more TMGIs associated with one or more corresponding MBS session identifiers, wherein each TMGI of the one or more TMGIs including one or more NID index values.

In a second additional aspect, alone or in combination with the first aspect, the MBS session information list is a first MBS session information list and the configuration includes a second MBS session information list, the second MBS session information list indicating one or more TMGIs associated with one or more corresponding PLMN identifiers and one or more service identifiers.

In a third additional aspect, alone or in combination with one or more of the first and second aspects, a number and order of MBS session identifiers included in the first MBS session information list matches a number and order of MBS session identifiers included in the second MBS session information list.

In a fourth additional aspect, alone or in combination with one or more of the first through third aspects, the first MBS session information list is separate from the second MBS session information list.

In a fifth additional aspect, alone or in combination with one or more of the first through fourth aspects, the first MBS session information list is an extension of the second MBS session information list.

In a sixth additional aspect, alone or in combination with one or more of the first through fifth aspects, mapping the NID index value to the NID comprises mapping the NID index value to an NID indicated in a non-public network (NPN) identity information list, the NPN identity information list including one or more NIDs associated with one or more SNPNs.

In a seventh additional aspect, alone or in combination with one or more of the first through sixth aspects, process 600 includes receiving the NPN identity information list in a SIB.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, by a network node that supports MIBS in an SNPN in accordance with the present disclosure. Example process 700 is an example where the network node (for example, network node 110) performs operations associated with supporting MBS in an SNPN.

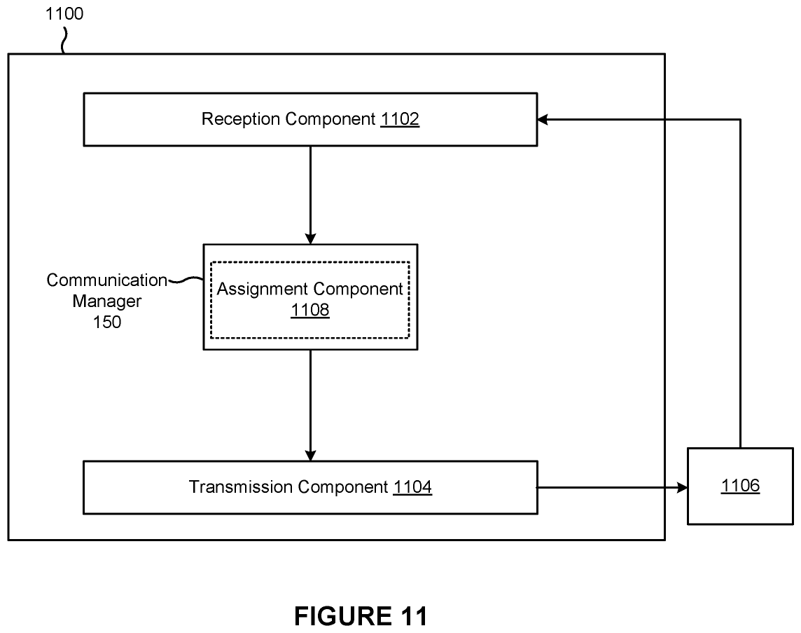

As shown in FIG. 7, in some aspects, process 700 may include transmitting a configuration indicating a TMGI associated with an MIBS session identifier associated with an MBS session provided by an SNPN, the TMGI including an NID index value corresponding to an NID associated with the MBS session (block 710). For example, the network node (such as by using communication manager 150 or transmission component 1104, depicted in FIG. 11) may transmit a configuration indicating a TMGI associated with an MBS session identifier associated with an MBS session provided by an SNPN, the TMGI including an NID index value corresponding to an NID associated with the MBS session, as described above.

As further shown in FIG. 7, in some aspects, process 700 may include transmitting a communication associated with the MIBS session for reception by a UE (block 720). For example, the network node (such as by using communication manager 150 or transmission component 1104, depicted in FIG. 11) may transmit a communication associated with the MBS session for reception by a UE, as described above.

Process 700 may include additional aspects, such as any single aspect or any combination of aspects described below or in connection with one or more other processes described elsewhere herein.

In a first additional aspect, the configuration includes an MBS session information list indicating one or more TMGIs associated with one or more corresponding MBS session identifiers, wherein each TMGI of the one or more TMGIs includes one or more NID index values.

In a second additional aspect, alone or in combination with the first aspect, the MBS session information list is a first MBS session information list and the configuration includes a second MBS session information list, the second MBS session information list indicating one or more TMGIs associated with one or more corresponding PLMN identifiers and one or more service identifiers.

In a third additional aspect, alone or in combination with one or more of the first and second aspects, a number and order of MBS session identifiers included in the first MBS session information list matches a number and order of MBS session identifiers included in the second MIBS session information list.

In a fourth additional aspect, alone or in combination with one or more of the first through third aspects, the first IBS session information list is separate from the second IBS session information list.

In a fifth additional aspect, alone or in combination with one or more of the first through fourth aspects, the first MBS session information list is an extension of the second MBS session information list.

In a sixth additional aspect, alone or in combination with one or more of the first through fifth aspects, process 700 includes transmitting an NPN identity information list in a SIB, the NPN identity information list including one or more NIDs associated with one or more SNPNs.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a flowchart illustrating an example process 800 performed, for example, by a UE that supports MBS in an SNPN in accordance with the present disclosure. Example process 800 is an example where the UE (for example, UE 120) performs operations associated with supporting MBS in an SNPN.

As shown in FIG. 8, in some aspects, process 800 may include receiving a configuration indicating a TMGI corresponding to an MBS session identifier associated with an TUBS session provided by an SNPN, the TMGI including a service identifier that is unique across a set of RAN sharing networks including one or more SNPNs or one or more PLMNs (block 810). For example, the UE (such as by using communication manager 140 or reception component 1002, depicted in FIG. 10) may receive a configuration indicating a TMGI corresponding to an MUBS session identifier associated with an MBS session provided by an SNPN, the TMGI including a service identifier that is unique across a set of RAN sharing networks including one or more SNPNs or one or more PLMNs, as described above.

As further shown in FIG. 8, in some aspects, process 800 may include receiving a communication associated with the MBS session based at least in part on the service identifier being unique across the set of RAN sharing networks (block 820). For example, the UE (such as by using communication manager 140 or reception component 1002, depicted in FIG. 10) may receive a communication associated with the MBS session based at least in part on the service identifier being unique across the set of RAN sharing networks, as described above.

Process 800 may include additional aspects, such as any single aspect or any combination of aspects described below or in connection with one or more other processes described elsewhere herein.

In a first additional aspect, the service identifier includes a particular set of bits from an NID associated with the SNPN providing the MBS session.

In a second additional aspect, alone or in combination with the first aspect, the particular set of bits includes one or more MSBs of the NID or an NID value field of the NID.

In a third additional aspect, alone or in combination with one or more of the first and second aspects, the particular set of bits includes one or more LSBs of the NID or an NID value field of the NID.

Although FIG. 8 shows example blocks of process 800, in some aspects, process 800 may include additional blocks, fewer blocks, different blocks, or differently arranged blocks than those depicted in FIG. 8. Additionally or alternatively, two or more of the blocks of process 800 may be performed in parallel.

FIG. 9 is a flowchart illustrating an example process 900 performed, for example, by a network node that supports MBS in an SNPN in accordance with the present disclosure. Example process 900 is an example where the network node (for example, network node 110) performs operations associated with supporting MBS in an SNPN.

As shown in FIG. 9, in some aspects, process 900 may include assigning a service identifier to an MBS session provided by an SNPN, the service identifier being unique across a set of RAN sharing networks including one or more SNPNs or one or more PLMNs (block 910). For example, the network node (such as by using communication manager 150 or assignment component 1108, depicted in FIG. 11) may assign a service identifier to an MBS session provided by an SNPN, the service identifier being unique across a set of RAN sharing networks including one or more SNPNs or one or more PLMNs, as described above.

As further shown in FIG. 9, in some aspects, process 900 may include transmitting a configuration indicating a TMGI corresponding to an MBS session identifier associated with the MBS session, the TMGI including the service identifier (block 920). For example, the network node (such as by using communication manager 150 or transmission component 1104, depicted in FIG. 11) may transmit a configuration indicating a TMGI corresponding to an MBS session identifier associated with the MBS session, the TMGI including the service identifier, as described above.

As further shown in FIG. 9, in some aspects, process 900 may include transmitting a communication associated with the MBS session for reception by a UE (block 930). For example, the network node (such as by using communication manager 150 or transmission component 1104, depicted in FIG. 11) may transmit a communication associated with the MBS session for reception by a UE, as described above.

Process 900 may include additional aspects, such as any single aspect or any combination of aspects described below or in connection with one or more other processes described elsewhere herein.

In a first additional aspect, assigning the service identifier comprises communicating with one or more other network nodes to ensure that the service identifier is unique across the set of RAN sharing networks.

In a second additional aspect, alone or in combination with the first aspect, assigning the service identifier comprises assigning the service identifier based at least in part on a particular set of bits from an NID associated with the SNPN providing the MBS session.

In a third additional aspect, alone or in combination with one or more of the first and second aspects, the particular set of bits includes one or more MSBs of the NID or an NID value field of the NID.

In a fourth additional aspect, alone or in combination with one or more of the first through third aspects, the particular set of bits includes one or more LSBs of the NID or an NID value field of the NID.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication that supports MBS in an SNPN in accordance with the present disclosure. The apparatus 1000 may be a UE, or a UE may include the apparatus 1000. In some aspects, the apparatus 1000 includes a reception component 1002, a transmission component 1004, and a communication manager 140, which may be in communication with one another (for example, via one or more buses). As shown, the apparatus 1000 may communicate with another apparatus 1006 (such as a UE, a network node, or another wireless communication device) using the reception component 1002 and the transmission component 1004.

In some aspects, the apparatus 1000 may be configured to perform one or more operations described herein in connection with FIGS. 4 and 5. Additionally or alternatively, the apparatus 1000 may be configured to perform one or more processes described herein, such as process 600 of FIG. 6 or process 800 of FIG. 8. In some aspects, the apparatus 1000 may include one or more components of the UE described above in connection with FIG. 2.

The reception component 1002 may receive communications, such as reference signals, control information, or data communications, from the apparatus 1006. The reception component 1002 may provide received communications to one or more other components of the apparatus 1000, such as the communication manager 140. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1002 may include one or more antennas, a modem, a demodulator, a MIMO detector, a receive processor, a controller/processor, or a memory of the UE described above in connection with FIG. 2.

The transmission component 1004 may transmit communications, such as reference signals, control information, or data communications, to the apparatus 1006. In some aspects, the communication manager 140 may generate communications and may transmit the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, or a memory of the UE described above in connection with FIG. 2. In some aspects, the transmission component 1004 may be co-located with the reception component 1002 in a transceiver.

In some aspects, the communication manager 140 may receive or may cause the reception component 1002 to receive a configuration indicating a TMGI corresponding to an MBS session identifier associated with an MBS session provided by an SNPN, the TMGI including an NID index value. In some aspects, the communication manager 140 may map the NID index value to an NID associated with the SNPN providing the MBS session. In some aspects, the communication manager 140 may receive or may cause the reception component 1002 to receive a communication associated with the MBS session based at least in part on the NID.

In some aspects, the communication manager 140 may receive or may cause the reception component 1002 to receive a configuration indicating a TMGI corresponding to an MBS session identifier associated with an MBS session provided by an SNPN, the TMGI including a service identifier that is unique across a set of RAN sharing networks including one or more SNPNs or one or more PLMNs. In some aspects, the communication manager 140 may receive or may cause the reception component 1002 to receive a communication associated with the MBS session based at least in part on the service identifier being unique across the set of RAN sharing networks. In some aspects, the communication manager 140 may perform one or more operations described elsewhere herein as being performed by one or more components of the communication manager 140.

The communication manager 140 may include a controller/processor or a memory of the UE described above in connection with FIG. 2. In some aspects, the communication manager 140 includes a set of components, such as a mapping component 1008. Alternatively, the set of components may be separate and distinct from the communication manager 140. In some aspects, one or more components of the set of components may include or may be implemented within a controller/processor or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

In some aspects, the reception component 1002 may receive a configuration indicating a TMGI corresponding to an MBS session identifier associated with an MBS session provided by an SNPN, the TMGI including an NID index value. In some aspects, the mapping component 1008 may map the NID index value to an NID associated with the SNPN providing the MBS session. In some aspects, the reception component 1002 may receive a communication associated with the MBS session based at least in part on the NID. In some aspects, the reception component 1002 may receive an NPN identity information list in a SIB.

In some aspects, the reception component 1002 may receive a configuration indicating a TMGI corresponding to an MBS session identifier associated with an MBS session provided by an SNPN, the TMGI including a service identifier that is unique across a set of RAN sharing networks including one or more SNPNs or one or more PLMNs. In some aspects, the reception component 1002 may receive a communication associated with the MBS session based at least in part on the service identifier being unique across the set of RAN sharing networks.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

FIG. 11 is a diagram of an example apparatus 1100 for wireless communication that supports MBS in an SNPN in accordance with the present disclosure. The apparatus 1100 may be a network node, or a network node may include the apparatus 1100. In some aspects, the apparatus 1100 includes a reception component 1102, a transmission component 1104, and a communication manager 150, which may be in communication with one another (for example, via one or more buses). As shown, the apparatus 1100 may communicate with another apparatus 1106 (such as a UE, a network node, or another wireless communication device) using the reception component 1102 and the transmission component 1104.

In some aspects, the apparatus 1100 may be configured to perform one or more operations described herein in connection with FIGS. 4 and 5. Additionally or alternatively, the apparatus 1100 may be configured to perform one or more processes described herein, such as process 700 of FIG. 7 or process 900 of FIG. 9. In some aspects, the apparatus 1100 may include one or more components of the network node described above in connection with FIG. 2.

The reception component 1102 may receive communications, such as reference signals, control information, or data communications, from the apparatus 1106. The reception component 1102 may provide received communications to one or more other components of the apparatus 1100, such as the communication manager 150. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a modem, a demodulator, a MIMO detector, a receive processor, a controller/processor, or a memory of the network node described above in connection with FIG. 2.

The transmission component 1104 may transmit communications, such as reference signals, control information, or data communications, to the apparatus 1106. In some aspects, the communication manager 150 may generate communications and may transmit the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, or a memory of the network node described above in connection with FIG. 2. In some aspects, the transmission component 1104 may be co-located with the reception component 1102 in a transceiver.

In some aspects, the communication manager 150 may transmit or may cause the transmission component 1104 to transmit a configuration indicating a TMGI associated with an MBS session identifier associated with an MBS session provided by an SNPN, the TMGI including an NID index value corresponding to an NID associated with the MBS session. In some aspects, the communication manager 150 may transmit or may cause the transmission component 1104 to transmit a communication associated with the MBS session for reception by a UE.

In some aspects, the communication manager 150 may assign a service identifier to an MBS session provided by an SNPN, the service identifier being unique across a set of RAN sharing networks including one or more SNPNs or one or more PLMNs. In some aspects, the communication manager 150 may transmit or may cause the transmission component 1104 to transmit a configuration indicating a TMGI corresponding to an MBS session identifier associated with the MBS session, the TMGI including the service identifier. In some aspects, the communication manager 150 may transmit or may cause the transmission component 1104 to transmit a communication associated with the MBS session for reception by a UE. In some aspects, the communication manager 150 may perform one or more operations described elsewhere herein as being performed by one or more components of the communication manager 150.

The communication manager 150 may include a controller/processor, a memory, a scheduler, or a communication unit of the network node described above in connection with FIG. 2. In some aspects, the communication manager 150 includes a set of components, such as an assignment component 1108. Alternatively, the set of components may be separate and distinct from the communication manager 150. In some aspects, one or more components of the set of components may include or may be implemented within a controller/processor, a memory, a scheduler, or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

In some aspects, the transmission component 1104 may transmit a configuration indicating a TMGI associated with an MBS session identifier associated with an MBS session provided by an SNPN, the TMGI including an NID index value corresponding to an NID associated with the IBS session. In some aspects, the transmission component 1104 may transmit a communication associated with the MUBS session for reception by a UE. In some aspects, the transmission component 1104 may transmit a non-public network (NPN) identity information list in a SIB, the NPN identity information list including one or more NIDs associated with one or more SNPNs.

In some aspects, the assignment component 1108 may assign a service identifier to an MBS session provided by an SNPN, the service identifier being unique across a set of RAN sharing networks including one or more SNPNs or one or more PLMNs. In some aspects, the transmission component 1104 may transmit a configuration indicating a TMGI corresponding to an MBS session identifier associated with the IBS session, the TMGI including the service identifier. In some aspects, the transmission component 1104 may transmit a communication associated with the IBS session for reception by a UE.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving a configuration indicating a TMGI corresponding to an MBS session identifier associated with an MBS session provided by an SNPN, the TMGI including an NID index value; mapping the NID index value to an NID associated with the SNPN providing the MBS session; and receiving a communication associated with the MBS session based at least in part on the NID.

Aspect 2: The method of Aspect 1, wherein the configuration includes an MBS session information list indicating one or more TMGIs associated with one or more corresponding MBS session identifiers, wherein each TMGI of the one or more TMGIs including one or more NID index values.

Aspect 3: The method of Aspect 2, wherein the MBS session information list is a first MBS session information list and the configuration includes a second MBS session information list, the second MBS session information list indicating one or more TMGIs associated with one or more corresponding PLMN identifiers and one or more service identifiers.

Aspect 4: The method of Aspect 3, wherein a number and order of MBS session identifiers included in the first MBS session information list matches a number and order of MBS session identifiers included in the second MBS session information list.

Aspect 5: The method of Aspect 3, wherein the first MBS session information list is separate from the second MBS session information list.

Aspect 6: The method of Aspect 3, wherein the first MBS session information list is an extension of the second MBS session information list.

Aspect 7: The method of any of Aspects 1-6, wherein mapping the NID index value to the NID comprises mapping the NID index value to an NID indicated in a non-public network (NPN) identity information list, the NPN identity information list including one or more NIDs associated with one or more SNPNs.

Aspect 8: The method of Aspect 7, further comprising receiving the NPN identity information list in a SIB.

Aspect 9: A method of wireless communication performed by a network node, comprising: transmitting a configuration indicating a TMGI associated with an MBS session identifier associated with an MBS session provided by an SNPN, the TMGI including an NID index value corresponding to an NID associated with the MBS session; and transmitting a communication associated with the MBS session for reception by a UE.

Aspect 10: The method of Aspect 9, wherein the configuration includes an MBS session information list indicating one or more TMGIs associated with one or more corresponding MBS session identifiers, wherein each TMGI of the one or more TMGIs includes one or more NID index values.

Aspect 11: The method of Aspect 10, wherein the MBS session information list is a first MBS session information list and the configuration includes a second MBS session information list, the second MBS session information list indicating one or more TMGIs associated with one or more corresponding PLMN identifiers and one or more service identifiers.

Aspect 12: The method of Aspect 11, wherein a number and order of MBS session identifiers included in the first MBS session information list matches a number and order of MBS session identifiers included in the second MBS session information list.

Aspect 13: The method of Aspect 11, wherein the first MBS session information list is separate from the second MBS session information list.

Aspect 14: The method of Aspect 11, wherein the first MBS session information list is an extension of the second MBS session information list.

Aspect 15: The method of any of Aspects 9-14, further comprising transmitting a non-public network (NPN) identity information list in a SIB, the NPN identity information list including one or more NIDs associated with one or more SNPNs.

Aspect 16: A method of wireless communication performed by a UE, comprising: receiving a configuration indicating a TMGI corresponding to an MBS session identifier associated with an MBS session provided by an SNPN, the TMGI including a service identifier that is unique across a set of RAN sharing networks including one or more SNPNs or one or more PLMNs; and receiving a communication associated with the MBS session based at least in part on the service identifier being unique across the set of RAN sharing networks.

Aspect 17: The method of Aspect 16, wherein the service identifier includes a particular set of bits from an NID associated with the SNPN providing the MBS session.

Aspect 18: The method of Aspect 17, wherein the particular set of bits includes one or more MSBs of the NID or an NID value field of the NID.

Aspect 19: The method of Aspect 17, wherein the particular set of bits includes one or more LSBs of the NID or an NID value field of the NID.

Aspect 20: A method of wireless communication performed by a network node, comprising: assigning a service identifier to an MBS session provided by an SNPN, the service identifier being unique across a set of RAN sharing networks including one or more SNPNs or one or more PLMNs; transmitting a configuration indicating a TMGI corresponding to an MBS session identifier associated with the MBS session, the TMGI including the service identifier; and transmitting a communication associated with the MBS session for reception by a UE.

Aspect 21: The method of Aspect 20, wherein assigning the service identifier comprises communicating with one or more other network nodes to ensure that the service identifier is unique across the set of RAN sharing networks.

Aspect 22: The method of any of Aspects 20-21, wherein assigning the service identifier comprises assigning the service identifier based at least in part on a particular set of bits from an NID associated with the SNPN providing the MBS session.

Aspect 23: The method of Aspect 22, wherein the particular set of bits includes one or more MSBs of the NID or an NID value field of the NID.

Aspect 24: The method of Aspect 22, wherein the particular set of bits includes one or more LSBs of the NID or an NID value field of the NID.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1-103. (canceled)

104. A user equipment (UE) for wireless communication, comprising:
at least one memory; and
at least one processor communicatively coupled with the at least one memory, the at least one processor operable to cause the UE to:
receive a configuration indicating a temporary mobile group identifier (TMGI) corresponding to a multicast and broadcast services (MBS) session identifier associated with an MBS session provided by a stand-alone non-public network (SNPN), the TMGI being associated with a service identifier that is unique across a set of radio access network (RAN) sharing networks including one or more SNPNs or one or more public land mobile networks (PLMNs); and
receive a communication associated with the MBS session based at least in part on the service identifier being unique across the set of RAN sharing networks.

105. The UE of claim 104, wherein the service identifier includes a particular set of bits from a network identifier (NID) associated with the SNPN providing the MBS session.

106. The UE of claim 105, wherein the particular set of bits includes one or more most significant bits (MSBs) of the NID or an NID value field of the NID.

107. The UE of claim 105, wherein the particular set of bits includes one or more least significant bits (LSBs) of the NID or an NID value field of the NID.

108. A network node for wireless communication, comprising:
at least one memory; and
at least one processor communicatively coupled with the at least one memory, the at least one processor operable to cause the network node to:
assign a service identifier to a multicast and broadcast services (MBS) session provided by a stand-alone non-public network (SNPN), the service identifier being unique across a set of radio access network (RAN) sharing networks including one or more SNPNs or one or more public land mobile networks (PLMNs);
transmit a configuration indicating a temporary mobile group identifier (TMGI) corresponding to an MBS session identifier associated with the MBS session, the TMGI being associated with the service identifier; and
transmit a communication associated with the MBS session for reception by a user equipment (UE).

109. The network node of claim 108, wherein, to cause the network node to assign the service identifier, the at least one processor is operable to cause the network node to communicate with one or more other network nodes to ensure that the service identifier is unique across the set of RAN sharing networks.

110. The network node of claim 108, wherein, to cause the network node to assign the service identifier, the at least one processor is operable to cause the network node to assign the service identifier based at least in part on a particular set of bits from a network identifier (NID) associated with the SNPN providing the MBS session.

111. The network node of claim 110, wherein the particular set of bits includes one or more most significant bits (MSBs) of the NID or an NID value field of the NID.

112. The network node of claim 110, wherein the particular set of bits includes one or more least significant bits (LSBs) of the NID or an NID value field of the NID.

113. A method of wireless communication performed by a user equipment (UE), comprising:
receiving a configuration indicating a temporary mobile group identifier (TMGI) corresponding to a multicast and broadcast services (MBS) session identifier associated with an MBS session provided by a stand-alone non-public network (SNPN), the TMGI including a service identifier that is unique across a set of radio access network (RAN) sharing networks including one or more SNPNs or one or more public land mobile networks (PLMNs); and
receiving a communication associated with the MBS session based at least in part on the service identifier being unique across the set of RAN sharing networks.

114. The method of claim 113, wherein the service identifier includes a particular set of bits from a network identifier (NID) associated with the SNPN providing the MBS session.

115. The method of claim 114, wherein the particular set of bits includes one or more most significant bits (MSBs) of the NID or an NID value field of the NID.

116. The method of claim 114, wherein the particular set of bits includes one or more least significant bits (LSBs) of the NID or an NID value field of the NID.

117. The UE of claim 104, wherein the configuration includes an MBS session information list indicating one or more TMGIs associated with one or more corresponding MBS session identifiers, wherein each TMGI of the one or more TMGIs is associated with one or more NID index values.

118. The UE of claim 104, wherein the at least one processor is further operable to cause the UE to map an index value to a network identifier (NID) indicated in a non-public network (NPN) identity information list, the NPN identity information list including one or more NIDs associated with the one or more SNPNs.

119. The network node of claim 108, wherein the configuration includes an MBS session information list indicating one or more TMGIs associated with one or more corresponding MBS session identifiers, wherein each TMGI of the one or more TMGIs is associated with one or more NID index values.

120. The method of claim 113, wherein the configuration includes an MBS session information list indicating one or more TMGIs associated with one or more corresponding MBS session identifiers, wherein each TMGI of the one or more TMGIs is associated with one or more NID index values.

121. The method of claim 113, further comprising mapping an index value to a network identifier (NID) indicated in a non-public network (NPN) identity information list, the NPN identity information list including one or more NIDs associated with the one or more SNPNs.
